(19) United States
(12) Patent Application Publication
(10) Pub. No.: US 2012/0054742 A1
(43) Pub. Date: Mar. 1, 2012

(54) State Separation Of User Data From Operating System In A Pooled VM Environment

(75) Inventors: Andrew Eremenko, Redmond, WA (US); Sriram Sampath, Redmond, WA (US); Ajay Kumar, Redmond, WA (US); Amjad Hussain, Kirkland, WA (US); Olga B. Ivanova, Redmond, WA (US); Raymond Matthew Reskusich, Seattle, WA (US)

(73) Assignee: Microsoft Corporation, Redmond, WA (US)

(21) Appl. No.: 12/874,109

(22) Filed: Sep. 1, 2010

(51) Int. Cl. G06F 9/455

(52) U.S. Cl. 718/1

(57) ABSTRACT

Techniques are provided for preserving state—both machine state and user state—in a virtual machine (VM) in a server deployment. User state may be preserved among a plurality of VMs in a server deployment by storing data specific to the user in a virtual hard drive (VHD). When a user logs into a particular VM, the VM remaps portions of a guest OS file system that correspond to user state to the VHD and mounts the VHD. Machine state may be preserved by storing information particular to a VM apart from that VM. When a VM is to be recreated, a diff disk containing the information particular to the VM is determined based on the current VM, the information particular to the VM, and a gold image that the VM is to be created with. Then, the VM is created with the gold image and the diff disk.

### BACKGROUND

It has been common to share a computer desktop and applications with a remote client using remote presentation protocol (RPP) technologies, such as Remote Desktop Protocol (RDP), Remote Desktop Session Host (RDSH), Terminal Services, and Remote Desktop Services (RDS) Such shared computing systems typically are established through instantiating a user session for the RPP session on the server of the session. Where the server's screen is to be shared with a client of the session, the RPP session obtains that information from a console session that is local to the server. During the RPP session, the client transmits the keyboard presses and mouse clicks or selections to the server, and the server sends screen updates back in the other direction to the client over a network connection (e.g., the INTERNET). As such, the user of the client has the experience as if his or her computer is executing the applications locally, when in reality the client computer is only sent screenshots of the applications as they appear on the server side.

In an environment where many remote presentation sessions are to be served concurrently, such as for a large corporation, these remote presentation sessions may be served by a plurality of virtual machines (VMs) on one physical server, or by a grouped plurality of servers, commonly referred to as a server farm or a server deployment. When a client computer connects to a server deployment, the client computer may conduct a remote presentation session with any of several VMs of the server deployment. Further, which VM the client computer conducts a remote presentation session with may change between sessions. There are many problems with server deployments, some of which are well known.

### SUMMARY

The present invention is directed to improved techniques for VM server deployments. These improved techniques are directed toward addressing problems preserving state within a server deployment. These problems of preserving state may be considered in two general categories—(1) the problems of preserving user state, and (2) the problems of preserving machine state.

With regard to the problems of preserving user state, When a user's computer (sometimes referred to as a client computer, or a client) connects to a deployment for the purpose of conducting a remote presentation session, the user's computer may be assigned to any of a plurality of VMs of the deployment. Even though the user's computer may be connected to any of those VMs, the user will expect that his data (files and/or profile information) is present on the VM to which he is connected.

There exist limited techniques for preserving user state by roaming a user's account or folder. These existing techniques are limited in a variety of ways. One way that these techniques are limited is that they are slow. These existing techniques copy a user's profile from a storage location to the VM at the start of a remote presentation session, then copy the user's profile back to the storage location at the conclusion of the session. Thus, where a user's profile is sufficiently large, this may take several minutes to perform, negatively impacting the user experience. A second way that these techniques are limited is that they are limited in what is roamed. Not all files that a user may expect to have are stored within the user's profile. For instance, an e-mail program may store e-mail messages somewhere in a file system outside of the user's profile, so merely roaming a user's profile will fail to roam those e-mail messages. Versions of the MICROSOFT OUTLOOK e-mail program act in this manner. Upon being executed on a particular machine for the first time, such versions of MICROSOFT OUTLOOK download all of a user's e-mail and create temporary files that index the e-mail, to assist in local search of it, and these temporary files are not preserved by existing techniques.

With regard to the problems of preserving machine state, it is common to reconstruct the VMs of a server deployment, and this act of reconstruction creates issues involving that machine's state. Reconstructing a VM comprises shutting down the VM, then creating it anew, either with the same guest operating system (guest OS) as before, or a new guest OS. Reconstructing a VM is a common operation used to, for instance, update a guest OS with a patch. Rather than patching each guest OS of the server deployment, a gold image of the patched guest OS is created, and this image is then copied to VMs. Individual machine state cannot be stored within the gold image because that individual machine state is unique to one guest OS and the gold image is used to create all of the guest OSes, so the gold image does not contain individual machine state. Thus, preserving machine state through the reconstruction of a VM is a problem.

It would therefore be an improvement to provide techniques for preserving user state and machine state in a manner that renders moot the problems associated with prior techniques. In an embodiment where user state is preserved, a connection broker of a server deployment receives a request from a user's computer to conduct a remote presentation session. The connection broker selects a VM of the VMs in the server deployment to conduct the remote presentation session, and indicates to the virtual machine host (VMHost—a computer of the server deployment upon which one or more VMs configured to serve remote presentation sessions may execute) on which this selected VM executes that the selected VM will serve the remote presentation session. The connection broker also indicates to the host an identifier of the user. The VMHost associates a virtual hard disk (VHD, a file that represents a physical hard disk to an entity that uses it, such as a guest OS) of the user with the selected VM, such that, when the user logs into a guest OS of the selected VM, the guest OS mounts the VHD, and remaps points in the guest OS's file system associated with user data to points within the VHD.

Then, when the user conducts a remote presentation session and attempts to access his or her data from the selected VM, the selected VM's guest OS will attempt to fetch that data within its file system, and, as a result of the remapping, that attempt will result in the guest OS fetching the corresponding data from the VHD. Where all of the VMs perform such remapping, regardless of the VM with which the user conducts a remote presentation session, his data will be available to him, as it is stored on a VHD.

In an embodiment, machine state is preserved. To preserve machine state, a connection broker of a server deployment determines that a VM of the server deployment is to be reconstructed. The connection broker sends an indication that the VM is to be reconstructed to a VMHost on which the VM is hosted, along with machine state information that is to be preserved, and an indication of which gold image to user to reconstruct the VM. Based on the machine state information received from the connection broker and the gold image to be used in reconstruction, the VMHost may create a differencing disk (sometimes referred to as a “diff disk”). The differencing disk here comprises information of the VM's machine state not found within the gold image. Then the VMHost shuts down the VM, and creates the VM using the gold image and the differencing disk, then sends the connection broker an indication that the VM has been reconstructed and is available to serve remote presentation sessions.

As used herein, a “gold image” and a “diff disk” may be thought of as specific types of image files. A gold image may be an image file that comprises base information about a VM—information about the VM and a guest operating system (guest OS) that executes within the VM that may be the same as another VM in the server farm. For instance, in versions of the MICROSOFT WINDOWS operating system, the win32.dll and win32k.sys files may be the same for multiple VMs, and these may be contained in a gold image. So, where two VMs in the server farm comprise the same version of the MICROSOFT WINDOWS operating system, a gold image used to image them may have contained the win32.dll and win32k.sys files. A diff disk, in contrast, may comprise information that uniquely identifies a VM among a plurality of VMs in the server farm. This unique information may comprise, for instance, an IP addressor a machine name or identifier. When the term “image file” (or, for example, “first image file”) is used herein, it may refer to a gold image or a diff disk, and this may be appreciated based on the context in which the term is used.

As described herein, a machine may be a physical machine or a virtual machine, unless otherwise made clear in discussing a particular machine.

It can be appreciated by one of skill in the art that one or more various aspects of the invention may include but are not limited to circuitry and/or programming for effecting the herein-referenced aspects of the present invention; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer-readable media for preserving state in a remote presentation session server deployment are further described with reference to the accompanying drawings in which:

FIG. 1 depicts an example general purpose computing environment in which in which techniques described herein may be embodied.

FIG. 2 depicts an example remote presentation session server wherein techniques described herein can be implemented.

FIG. 3A depicts an example virtual machine host wherein techniques described herein can be implemented.

FIG. 3B depicts a second example virtual machine host wherein techniques described herein can be implemented.

FIG. 4 depicts an example server deployment where techniques for preserving user state may be implemented.

FIG. 5 depicts example operating procedures for preserving user state.

FIG. 6 depicts an example server deployment where techniques for preserving machine state may be implemented.

FIG. 7 depicts example operating procedures for preserving machine state.

### DETAILED DESCRIPTION OF ILLUSTRATIVE EMBODIMENTS

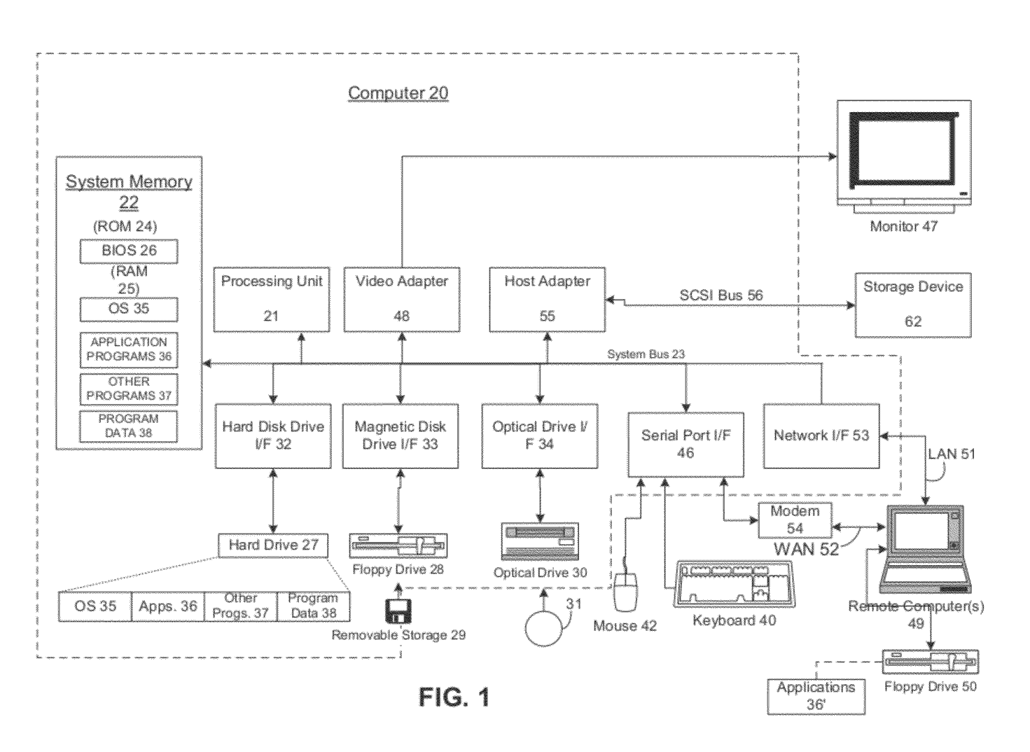

Embodiments may execute on one or more computer systems. FIG. 1 and the following discussion are intended to provide a brief general description of a suitable computing environment in which the disclosed subject matter may be implemented.

The term circuitry used throughout the description can include hardware components such as hardware interrupt controllers, hard drives, network adaptors, graphics processors, hardware based video/audio codecs, and the firmware used to operate such hardware. The term circuitry can also include microprocessors, application specific integrated circuits, and/or one or more logical processors, e.g., one or more cores of a multi-core general processing unit configured by instructions read from firmware and/or software. Logical processor(s) can be configured by instructions embodying logic operable to perform function(s) that are loaded from memory, e.g., RAM, ROM, firmware, and/or mass storage. In an example embodiment where circuitry includes a combination of hardware and software, an implementer may write source code embodying logic that is subsequently compiled into machine readable code that can be executed by a logical processor. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary general purpose computing system is depicted. The general purpose computing system can include a conventional computer 20 or the like, including at least one processor or processing unit 21, a system memory 22, and a system bus 23 that communicative couples various system components including the system memory to the processing unit 21 when the system is in an operational state. The system bus 23 may be any of several types of bus structures including a memory bus or memory controller, a peripheral bus, and a local bus using any of a variety of bus architectures. The system memory can include read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37 and program data 38. Upon execution by the processing unit, the computer-readable instructions cause the actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

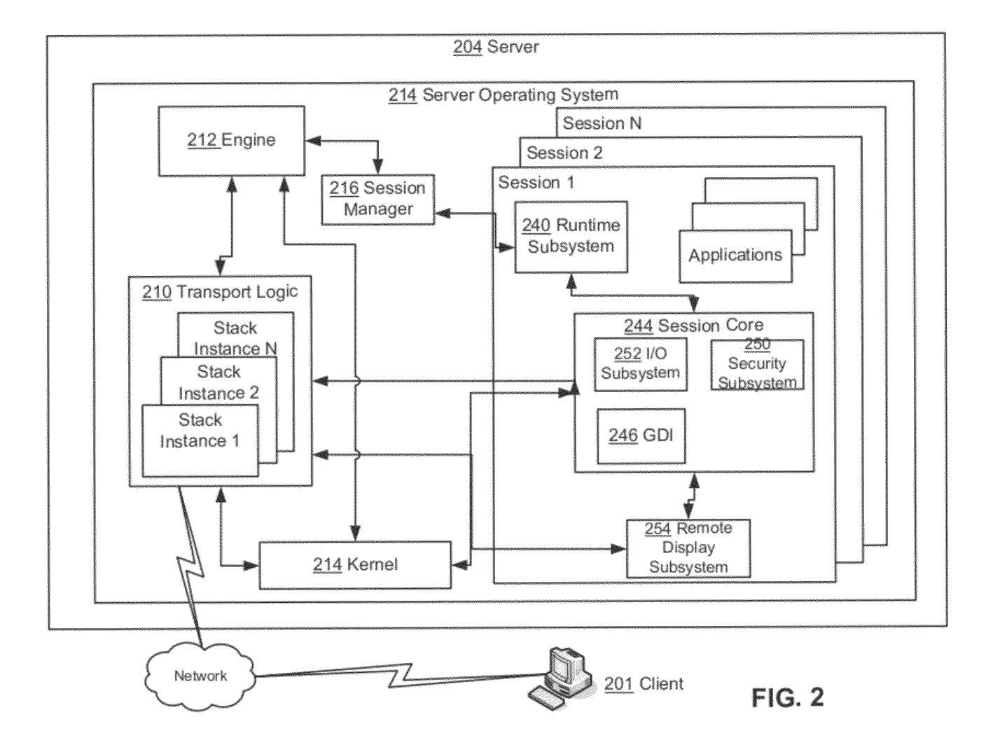

FIG. 2 depicts an example environment wherein aspects of the present invention can be implemented. The example environment may comprise the computer depicted in FIG. 1. One skilled in the art can appreciate that the example elements depicted by FIG. 2 are illustrated to provide an operational framework for describing the present invention. Accordingly, in some embodiments the physical layout of each environment may be different depending on different implementation schemes. Thus the example operational framework is to be treated as illustrative only and in no way limit the scope of the claims. One skilled in the art can also appreciate that the following discussion is introductory.

Generally, FIG. 2 depicts a high level overview of a server environment that can be configured to include aspects of the present invention. In reference to the figure, depicted is a server 204 that can include circuitry configured to effectuate a remote presentation session server, or in other embodiments the server 204 can include circuitry configured to support remote presentation connections. In the depicted example, the server 204 can be configured to generate one or more sessions for connecting clients such as sessions 1 through N (where N is an integer greater than 1). Briefly, a session in example embodiments of the present invention can generally include an operational environment that is effectuated by a plurality of subsystems (e.g., software code) that are configured to interact with a kernel 214 of server 204. For example, a session can include a process that instantiates a user interface such as a desktop window, the subsystems that track mouse movement within the window, the subsystems that translate a mouse click on an icon into commands that effectuate an instance of a program, etc. A session can be generated by the server 204 on a user-by-user basis by the server 204 when, for example, the server 204 receives a connection request over a network connection from a client 201. Generally, a connection request can first be handled by the transport logic 210 that can, for example, be effectuated by circuitry of the server 204. The transport logic 210 can in some embodiments include a network adaptor; firmware, and software that can be configured to receive connection messages and forward them to the engine 212. As illustrated by FIG. 2, the transport logic 210 can in some embodiments include protocol stack instances for each session. Generally, each protocol stack instance can be configured to route user interface output to a client and route user input received from the client to the session core 244 associated with its session.

Continuing with the general description of FIG. 2, the engine 212 in some example embodiments of the present invention can be configured to process requests for sessions; determine the functionality for each session; generate sessions by allocating a set of physical resources for the session; and instantiating a protocol stack instance for the session. In some embodiments the engine 212 can be effectuated by specialized circuitry components that can implement some of the above mentioned operational procedures. For example, the circuitry in some example embodiments can include memory and a processor that is configured to execute code that effectuates the engine 212. As depicted by FIG. 2, in some instances the engine 212 can receive connection requests and determine that, for example, a license is available and a session can be generated for the request. In the situation where the server 204 is a remote computer that includes remote presentation session capabilities, the engine 212 can be configured to generate a session in response to a connection request without checking for a license. As illustrated by FIG. 2, a session manager 216 can be configured to receive a message from an engine 212 and in response to the message the session manager 216 can add a session identifier to a table; assign memory to the session identifier; and generate system environment variables and instances of subsystem processes in memory assigned to the session identifier.

As illustrated by FIG. 2, the session manager 216 can instantiate environment subsystems such as a runtime subsystem 240 that can include a kernel mode part such as the session core 244. For example, the environment subsystems in an embodiment are configured to expose some subset of services to application programs and provide an access point to the kernel of the operating system 214. In example embodiments the runtime subsystem 240 can control the execution of processes and threads and the session core 244 can send requests to the executive of the kernel 214 to allocate memory for the threads and schedule time for them to be executed. In an embodiment the session core 244 can include a graphics display interface 246 (GDI), a security subsystem 250, and an input subsystem 252. The input subsystem 252 can in these embodiments be configured to receive user input from a client 201 via the protocol stack instance associated with the session and transmit the input to the session core 244 for the appropriate session. The user input can in some embodiments include signals indicative of absolute and/or relative mouse movement commands, mouse coordinates, mouse clicks, keyboard signals, joystick movement signals, etc. User input, for example, a mouse double-click on an icon, can be received by the session core 244 and the input subsystem 252 can be configured to determine that an icon is located at the coordinates associated with the double-click. The input subsystem 252 can then be configured to send a notification to the runtime subsystem 240 that can execute a process for the application associated with the icon.

In addition to receiving input from a client 201, draw commands can be received from applications and/or a desktop and be processed by the GDI 246. The GDI 246 in general can include a process that can generate graphical object draw commands. The GDI 246 in this example embodiment can be configured to pass its output to the remote presentation subsystem 254 where the commands are formatted for the display driver that is attached to the session. In certain example embodiments one or more physical displays can be attached to the server 204, e.g., in a remote presentation session situation. In these example embodiments the remote presentation subsystem 254 can be configured to mirror the draw commands that are rendered by the display driver(s) of the remote computer system and transmit the mirrored information to the client 201 via a stack instance associated with the session. In another example embodiment, where the server 204 is a remote presentation session server, the remote presentation subsystem 254 can be configured to include virtual display driver(s) that may not be associated with displays physically attacked to the server 204, e.g., the server 204 could be running headless. The remote presentation subsystem 254 in this embodiment can be configured to receive draw commands for one or more virtual displays and transmit them to the client 201 via a stack instance associated with the session. In an embodiment of the present invention, the remote presentation subsystem 254 can be configured to determine the display resolution for each display driver, e.g., determine the display resolution of the virtual display driver(s) associated with virtual displays or the display resolution of the display drivers associated with physical displays; and route the packets to the client 201 via the associated protocol stack instance.

In some example embodiments the session manager 216 can additionally instantiate an instance of a logon process (sometimes referred to as a log in process) associated with the session identifier of the session that can be configured to handle logon and logoff for the session. In these example embodiments drawing commands indicative of the graphical user interface associated with the logon process can be transmitted to the client 201 where a user of the client 201 can input an account identifier, e.g., a username/password combination, a smart card identifier, and/or biometric information into a logon screen. The information can be transmitted to server 204 and routed to the engine 212 and the security subsystem 250 of the session core 244. For example, in certain example embodiments the engine 212 can be configured to determine whether the user account is associated with a license; and the security subsystem 250 can be configured to generate a security token for the session.

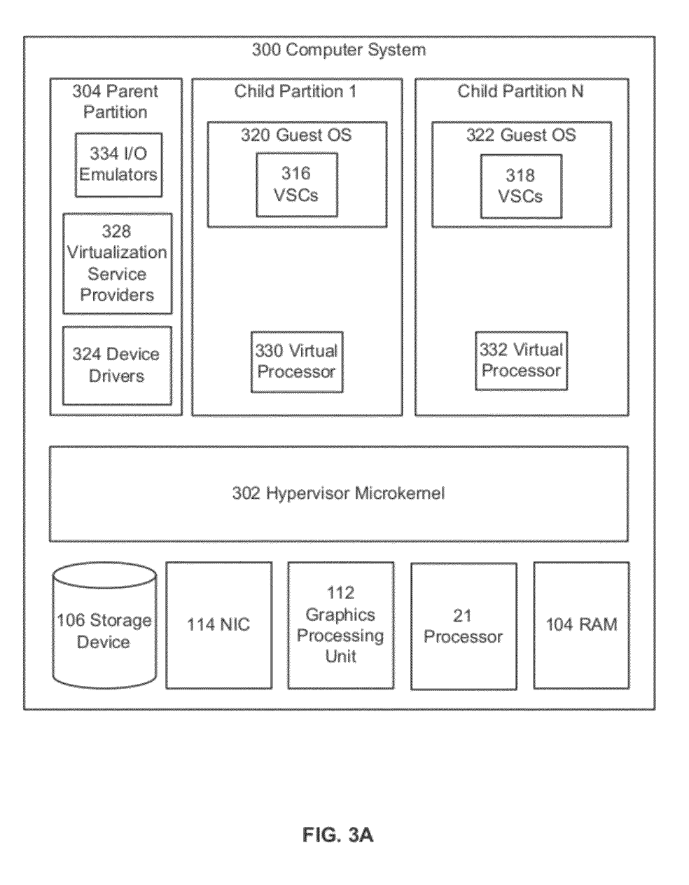

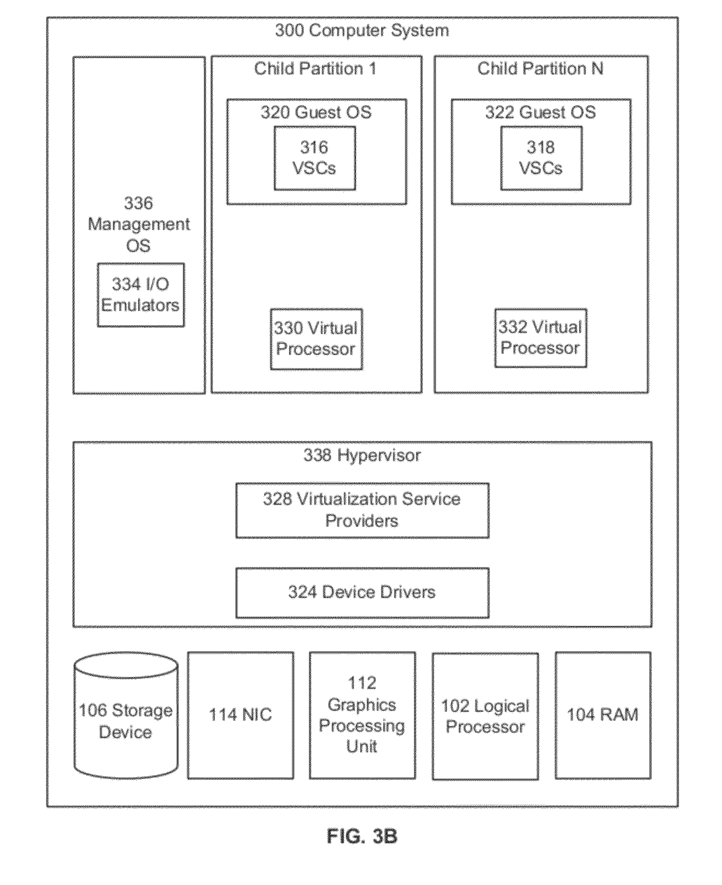

FIG. 3A depicts an example VMHost wherein techniques described herein can be implemented. The VMHost can be implemented on a computer such as the one depicted in FIG. 1, and VMs on the VMHost may execute an operating system that effectuates a remote presentation session server, such as server operating system 214 of FIG. 2.

Hypervisor microkernel 302 can enforce partitioning by restricting a guest operating system's view of system memory. Guest memory is a partition's view of memory that is controlled by a hypervisor. The guest physical address can be backed by system physical address (SPA), i.e., the memory of the physical computer system, managed by hypervisor. In an embodiment, the GPAs and SPAs can be arranged into memory blocks, i.e., one or more pages of memory. When a guest writes to a block using its page table, the data is actually stored in a block with a different system address according to the system wide page table used by hypervisor.

In the depicted example, parent partition component 304, which can also be also thought of as similar to “domain 0” in some hypervisor implementations, can interact with hypervisor microkernel 302 to provide a virtualization layer. Parent partition 304 in this operational environment can be configured to provide resources to guest operating systems executing in the child partitions 1-N by using virtualization service providers 328 (VSPs) that are sometimes referred to as “back-end drivers.” Broadly, VSPs 328 can be used to multiplex the interfaces to the hardware resources by way of virtualization service clients (VSCs) (sometimes referred to as “front-end drivers”) and communicate with the virtualization service clients via communication protocols. As shown by the figures, virtualization service clients can execute within the context of guest operating systems. These drivers are different than the rest of the drivers in the guest in that they may be supplied with a hypervisor, not with a guest.

Emulators 334 (e.g., virtualized integrated drive electronics device (IDE devices), virtualized video adaptors, virtualized NICs, etc.) can be configured to run within the parent partition 304 and are attached to resources available to guest operating systems 320 and 322. For example, when a guest OS touches a register of a virtual device or memory mapped to the virtual device 302, microkernel hypervisor can intercept the request and pass the values the guest attempted to write to an associated emulator.

Each child partition can include one or more virtual processors (330 and 332) that guest operating systems (320 and 322) can manage and schedule threads to execute thereon. Generally, the virtual processors are executable instructions and associated state information that provide a representation of a physical processor with a specific architecture. For example, one virtual machine may have a virtual processor having characteristics of an INTEL x86 processor, whereas another virtual processor may have the characteristics of a PowerPC processor. The virtual processors in this example can be mapped to logical processors of the computer system such that the instructions that effectuate the virtual processors will be backed by logical processors. Thus, in an embodiment including multiple logical processors, virtual processors can be simultaneously executed by logical processors while, for example, other logical processors execute hypervisor instructions. The combination of virtual processors and memory in a partition can be considered a virtual machine.

Guest operating systems can include any operating system such as, for example, a MICROSOFT WINDOWS operating system. The guest operating systems can include user/kernel modes of operation and can have kernels that can include schedulers, memory managers, etc. Generally speaking, kernel mode can include an execution mode in a logical processor that grants access to at least privileged processor instructions. Each guest operating system can have associated file systems that can have applications stored thereon such as terminal servers, e-commerce servers, email servers, etc., and the guest operating systems themselves. The guest operating systems can schedule threads to execute on the virtual processors and instances of such applications can be effectuated.

FIG. 3B depicts a second example VMHost wherein techniques described herein can be implemented. FIG. 3B depicts similar components to those of FIG. 3A; however in this example embodiment the hypervisor 338 can include the microkernel component and components from the parent partition 304 of FIG. 3A such as the virtualization service providers 328 and device drivers 324 while management operating system 336 may contain, for example, configuration utilities used to configure hypervisor 304. In this architecture hypervisor 338 can perform the same or similar functions as hypervisor microkernel 302 of FIG. 3A; however, in this architecture hypervisor 334 can be configured to provide resources to guest operating systems executing in the child partitions. Hypervisor 338 of FIG. 3B can be a stand alone software product, a part of an operating system, embedded within firmware of the motherboard or a portion of hypervisor 338 can be effectuated by specialized integrated circuits.

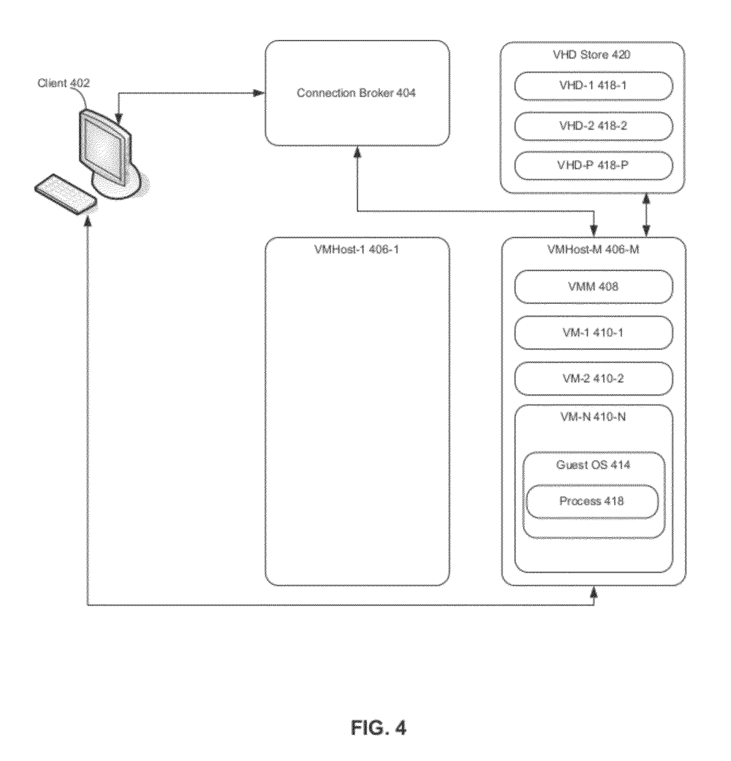

FIG. 4 depicts an example server deployment where techniques for preserving user state may be implemented. Components of FIG. 4 may be effectuated, for instance, using the computer of FIG. 1, the remote presentation server of FIG. 2, and the VMHosts of FIGS. 3A and 3B.

A remote presentation session server deployment comprises connection broker 404, at least one VMHost 406 that hosts VMs that serve remote presentation sessions with clients (depicted herein as M number of VMHosts: VMHost-1 406-1 through VMHost-M) and a VHD store 420 that stores one or more VHDs (depicted herein as P number of VHDs: VHD-1 418-1, VHD-2 418-2, through VHD-P 418-P). VM Store 420 may comprise, for instance, a storage area network (SAN). In turn, VMHost-M 406-M comprises virtual machine manager (VMM, also referred to as a hypervisor) 408, and one or more VMs (depicted herein as VM-1 410-1, VM-2 410-2, through VM-N 410-N). In turn VM-N 410-N comprises guest OS 414. Guest OS 414 comprises process 418, which is configured to, upon user account logon to guest OS 414, execute to remap portions of the file system of guest OS 414 to VHD 418 (this is sometimes referred to as mapping portions of the file system).

Before describing the techniques involved with preserving user state, a remote presentation session is initialized between client 402 and VM-N 410-N as follows. When client 402 requests to initialize a remote presentation session with the server deployment, that request is received by connection broker 404. Connection broker 404 is configured to communicate with each VMHost 406-1 through 406-M. Upon receiving the request from client 402, connection broker 404 can select or determine a VM hosted by a VMHost of the server deployment that will serve the remote presentation session to client 402. Connection broker 404 may make this determination according to a variety of considerations, such as to balance the load among the VMs and the VMHosts. Connection broker 404 sends the VMHost determined VM (depicted here as VMHost-M 406-M, which hosts VM-N 410-N) an indication that it is to conduct a remote presentation session with client 402. This may comprise sending a “spin up” command or message to VMHost 406-M, which then conveys the message to VM-N 410-N. Upon VM-N 410-N being ready to conduct a remote presentation session with client 402, VMHost 406-M may send an acknowledgement to the “spin up” command to connection broker 404, such as a “spin complete” message. Connection broker 404 also sends an indication of VM-N 410-N to client 402. This indication may comprise, for instance, an INTERNET protocol (IP) address of VM-N 410-N, and a machine name of VM-N 410-N. Client 402 then uses the indication of VM-N 410-N to connect to VM-N 410-N and engage with VM-N 410-N in a remote presentation session.

The techniques that directly incorporate preserving user state enter the above process flow at the point where connection broker 404 sends VMHost-M 406-M an indication that VM-N 410-N is to conduct a remote presentation session with client 402. This indication may comprise a indication of a user account that client 402 will use in conducting the remote presentation session, such as a SUID in a MICROSOFT WINDOWS operating system—a unique identifier among user accounts that may conduct a remote presentation session with the server deployment. VMM 408 may take this SUID and use it to determine a VHD 418 stored on VHD store 420 that contains the user's data. VMM then associates this VHD 418 with VM-N, such that when client 402 logs into guest OS 414, guest OS will mount VHD 418.

Client 402 then logs in to guest OS 414 of VM-N 410-N. Upon logon, guest OS 414 mounts VHD 418 and process 416 remap portions of a file system of guest OS 414 to portions of VHD 418. Process 416 may execute upon logon to guest OS 414, for instance, by setting guest OS 414 to include process 416 among those processes that it executes upon user logon. This remapping performed by process 416 may comprise, for instance, replacing files in the file system of guest OS 414 with links (symbolic links or hard links) to files in the VHD 418, or effecting a similar outcome with analogous techniques, such as through the use of mount points. Before performing these operations, process 416 may first determine that client 402 has not logged into guest OS 414 since VM-N 410-N was most recently created. For instance, if client 402 has already logged into guest OS 414, then the remapping process may have already occurred and does not need to take place anew.

Process 416 may determine which files to map to VHD 418, for instance, such as through a roaming policy. Connection broker 404 may maintain a roaming policy for the server deployment. In addition to sending an indication to VMHost-M 406-M that one of its VMs 410 will conduct a particular remote presentation session, and an indication of a user account of client 402, connection broker 404 may also send VMHost-M 406-M an indication of a roaming policy that sets forth what user data is to be roamed between VMs 410, and therefore remapped from a guest OS's 404 file system to a VHD 418. Other information to be indicated by a roaming policy may include whether roaming of user data is enabled or not, and a uniform resource locator (URL) that indicates the location of the VHD 418 corresponding to the user account that will participate in the remote presentation session.

Because files are mapped rather than copied, changes or modifications that client 402 makes to those mapped files are reflected in VHD 418 the same as if guest OS 414 wrote those changes to a local disk, and guest OS 414 also reads those files the same as if it were reading files from a local disk, so there is no need to either copy files to guest OS 414 before they are first utilized within a remote presentation session, nor is there a need to copy changed files back to VHD Store 420 at some later point, such as the conclusion of a remote presentation session.

It may be that guest OS mounts a plurality of VHDs 418 upon user logon. In such a scenario, process 416 may determine which VHD 418 of the plurality of VHDs 418 corresponds to the user's data by enumerating the plurality of VHDs 418, and checking them to find one that has a signifier (sometimes referred to as a “binding blob”) that it stores the user's data. Where connection broker 404 sends a SUID to identify the user to VMHost-M 406-M, this signifier may comprise a user's SUID stored in a file within the VHD. Where process 416 determines a match between a SUID received from connection broker 404 and a SUID stored within a file of a VHD 418, it may determine that this VHD 418 is the VHD 418 that stores the user's data.

Such a scenario where a guest OS mounts a plurality of VHDs may occur where a guest OS serves a plurality of concurrent remote presentation sessions—such as where the guest OS functions as a terminal server. In such a scenario, each user of a concurrent remote presentation session may have an associated VHD that is mounted by the guest OS.

Where the user account later conducts a second remote presentation session with the server farm, the remote presentation session may be conducted by a different VM 410 of the server deployment. When this occurs, similar techniques as described above may be implemented to remap portions of a file system of the different VM 410 to the user account's VHD 418, thereby preserving user state across the VMs 410 of the server deployment.

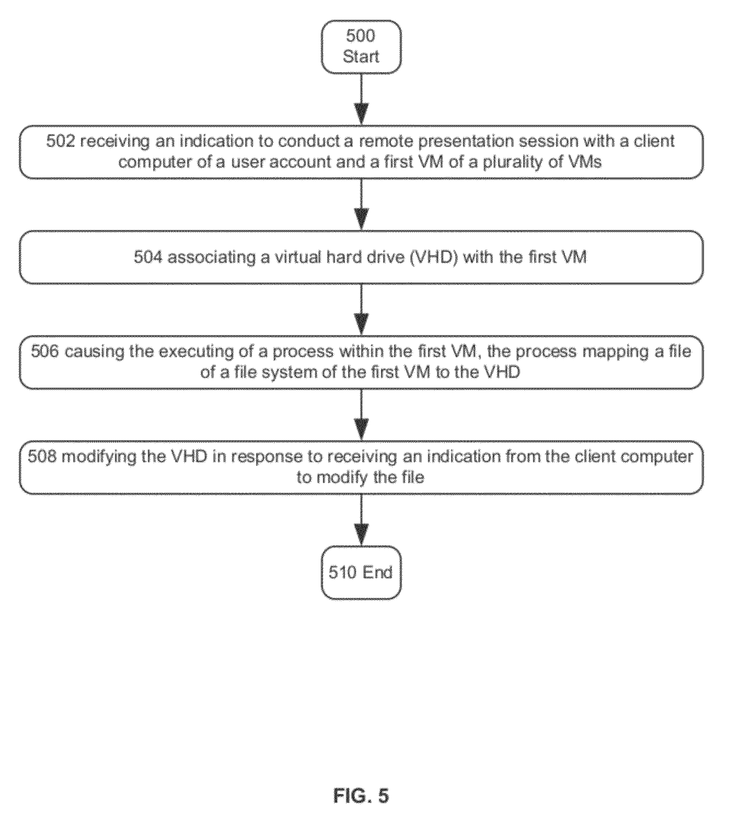

FIG. 5 depicts example operating procedures for preserving user state. The operating procedures of FIG. 5 may be implemented in the server deployment of FIG. 4.

The operating procedures of FIG. 5 begin with operation 500. Operation 500 leads into Operation 502, which depicts receiving an indication to conduct a remote presentation session with a client computer of a user account and a first VM of a plurality of VMs. For instance, a connection broker that distributes incoming requests for remote presentation sessions for a server deployment may receive this indication from a client that desires to conduct a remote presentation session with a VM on the server deployment. The connection broker may further determine that the first VM is the VM that will conduct the remote presentation session with the client.

Operation 504 depicts associating a virtual hard drive (VHD) with the first VM. The VHD may be used to store user state so that user state is preserved for the user regardless of which VM he is connected to, so long as the VHD is available to that VHD. Associating the VHD with the first VM may comprise configuring the VM such that the VM will determine that the VHD exists and mount the VHD so that it is available to the client's session within the VM. This act of associating may comprise modifying the first VM such that a guest operating system (OS) executing within the first VM mounts the VHD upon the user account logging into the guest OS.

In an embodiment, operation 504 comprises determining that the user account has not logged into the first VM since the first VM was most recently created. If the user account has already logged into the first VM, the VHD may already be associated with the first VM due to performing the operation procedures of FIG. 5 in response to that prior login. If that is the case, it may be redundant to associate a VHD that is already associated with the VHD.

In an embodiment, operation 504 comprises determining that the VHD of a plurality of VHDs that corresponds to the user account based on data stored in the VHD. The server deployment may comprise a plurality of VHDs for a plurality of users whose state is to be preserved. Furthermore, more than one of these VHDs may be associated with the first VM because more than one user has initialized a remote presentation session with the first VM. In this scenario, the first VM will have a plurality of VHDs at its disposal and may determine which of that plurality of VHDs is the present user's VHD. The connection broker may determine this by looking for data stored on the VHD that uniquely identifies the user as against the other users. This could be, for instance, a SUID of the user. Where the connection broker finds this data on a VHD, it may determine that this is the VHD that corresponds to the user account.

Operation 506 depicts causing the executing of a process within the first VM, the process mapping a file of a file system of the first VM to the VHD. This may comprise setting a guest OS executing within the first VHD to execute the process on boot up or upon the user account logging into the guest OS, and this process then maps the file from the file system to the VHD.

In an embodiment, operation 506 comprises sending the process an indication of a roaming policy; and causing the execution of a process within the first VM, the process mapping the file location of the file system of the first VM to the VHD based on the roaming policy. There may be a roaming policy that sets forth what files or data is to be roamed to the VHD, and thus should be remapped by the process from a VM file system to the VHD. The process may consult or otherwise adhere to the roaming policy in mapping portions of the file system to the VHD.

In an embodiment, operation 506 comprises the process creating a mount point, a symbolic link, or a hard link between the file and the VHD. Through these actions, the process may effectuate the mapping of a portion of the file system, such as a file, to the VHD.

In an embodiment wherein the guest OS mounts a plurality of VHDs upon the user account logging into the guest OS, and wherein causing the execution of a process within the first VM, operation 506 comprises determining that data stored in the VHD corresponds to the user account. For example, the VHD may store a file or otherwise contain data that uniquely identifies the user account as against other user accounts in the system. The user account may be uniquely identified, for instance, by storing the SUID for the user on the VHD.

Operation 508 depicts modifying the VHD in response to receiving an indication from the client computer to modify the file. When the user account modifies a file in the file system that has been mapped to the VHD, the instruction to modify the file may indicate that the file is located within the file system. However, due to the mapping of the file to the VHD, the file is actually located on the VHD, and because of the mapping, this instruction is carried out on the file as stored on the VHD. In this manner, if the user logs into another VM, and this VHD is mapped to that other VM's file system, the user's state is preserved for his session with this other VM.

Operation 510 depicts receiving an indication to conduct a second remote presentation session with the client computer of the user account or a second client computer of the user account and a second VM of the plurality of VMs; associating the virtual hard drive (VHD) with the second VM; causing the execution of a process within the second VM, the process mapping a file of a file system of the second VM to the VHD; and in response to an indication received from the client computer to modify the file of the second VM, modifying the VHD. Similarly as to described with respect to operation 508, when the user logs into a second VM, the same VHD for the user is associated with this second VM, and portions of a file system of the second VM are mapped to the VHD. Then, the user may read, write or otherwise modify (so long as he has sufficient permissions) the file that he modified on the first VM while logged into the second VM, and user state is preserved between VMs.

At the conclusion of operation 510, the operation procedures move to operation 512 where the operation procedures of FIG. 5 end.

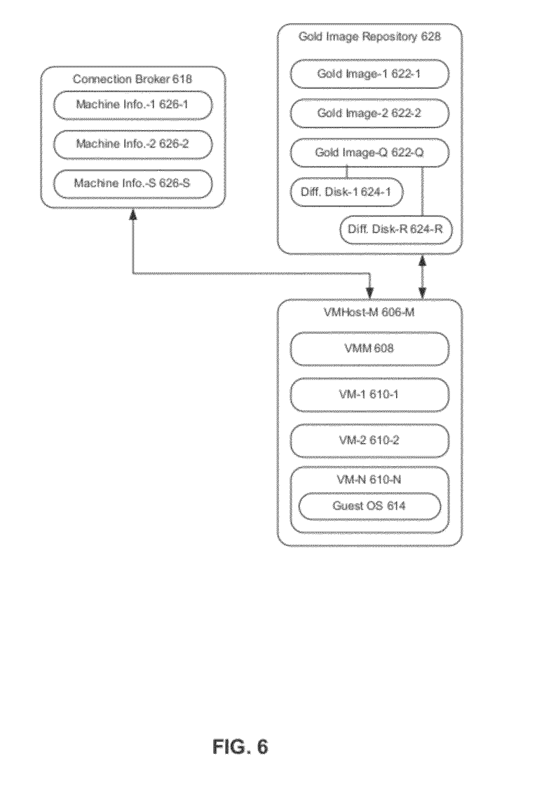

FIG. 6 depicts an example server deployment where techniques for preserving machine state may be implemented. Components of FIG. 6 may be effectuated, for instance, using the computer of FIG. 1, the remote presentation server of FIG. 2, and the VMHosts of FIGS. 3A and 3B.

VMHost-N 606-N may be similar to VMHost-M 406-M of FIG. 4, and likewise, the components that it comprises—VMM 608, VM-1 610-1, VM-2 610-2, VM-N 610-N, and guest OS 614—may be similar to components depicted in FIG. 4—respectively, VMM 408, VM-1 410-1, VM-2 410-2, VM-N 410-N, and guest OS 414. As well, connection broker 618 may be similar to connection broker 418 of FIG. 4. As depicted in FIG. 6, connection broker 618 stores a plurality of machine information, machine info-1 626-1, machine info-2 626-2, through machine info-S 626-S. Machine info 626 comprises information about a VM 610 of the server deployment, such as a machine identifier, and an IP address associated with the VM 610.

As depicted in FIG. 6, a server deployment in which techniques for preserving machine state may be implemented also comprises gold image repository 628. Gold image repository stores a plurality of gold images (depicted herein as gold image-1 622-1, gold image-2 622-2, through gold image-Q 622-Q). Each gold image comprises an operating system that may be used to image a VM 610 with a guest OS. For instance, gold image-1 622-1 may comprise the MICROSOFT WINDOWS 7 operating system, and gold image-2 622-2 may comprise the MICROSOFT WINDOWS 7 operating system with the Service Pack 1 collection of updates, fixes and enhancements installed thereon. As gold image 622 may be used to image a plurality of VMs, gold image 622 may lack machine-specific information, such as a machine identifier, or an IP address associated with a machine.

Gold image repository 628 may also comprise one or more differencing disks (or “diff disks,” herein depicted as diff disk-1 624-1 through diff disk-R 624-R). A differencing disk is associated with, or depends from, a gold image (here, diff disk 624-1 and 624-R are associated with gold image-Q 622-Q; in some cases, the diff disk is referred to as the “child” disk, and the gold image the “parent” disk). A differencing disk may be used to store changes, or differences, between a gold image 622 and a particular image of a VM 610. For instance, whereas a gold image 622 may comprise no information unique to a VM 610 but only information that may be applied to any VM 610, a diff disk 624 may be used to store information that identifies a VM 610, and a different diff disk 624 may be used for each VM 610 that is imaged with a particular gold image 622. Both gold images 622 and diff disks 624 may comprise VHD files. As used herein, information that identifies a VM may comprise information not shared by every VM in a server deployment, or that identifies a VM within a server deployment—such as a machine name or an INTERNET Protocol (IP) address. Information that identifies a VM may be unique as among VMs currently executing within the server farm. However, that information may not be unique among all VMs over a period of time. For instance, it may be that, in recreating a VM, both the VM and the newly created VM that replaces it share that information.

While not depicted in FIG. 6, there may be multiple layers of diff disks 610. That is, a diff disk 624 may be a child of another diff disk 624 (which, in turn, is a child of a gold image 622).

The initial operation in recreating a VM 610 while preserving machine state is determining that a VM 610 is to be recreated. This may be performed, for instance, by connection broker 618. Connection broker 618 may determine that a VM 610 is to be recreated, for instance, when there is a new gold image 622 to be applied to it (such as if there is a new patch for the current guest OS, and that new patch has been applied to the new gold image 622), and the VM is serving no remote presentation sessions. Another reason that connection broker 618 may determine to recreate a VM 610 is if the server farm periodically recreates VMs (such as every two weeks) to ensure that the state of the VM does not become corrupted.

In response to determining to recreate a VM 610, connection broker 618 sends a message to the VMHost 606 that hosts the VM 610 indicative of this recreation process. This message sent from connection broker 618 to VMHost 606 may include machine information 626 that corresponds to the VM 610 that is to be recreated, and an indication (such as a URL) of a gold image 622 stored on gold image repository 628 that will be used to recreate the VM 610. This machine information 626 may be stored, for instance, as an extensible markup language (XML) file by connection broker 618.

VMHost 606 receives the message sent from connection broker 618 to recreate a particular VM, and uses the received machine information 626 and the indicated gold image 622 to create a diff disk 624 that contains the information for the VM 610 to be recreated. For instance, diff disk 624 may comprise a file in a file system of gold image 622 that contains the information that identifies a VM. For instance, in a MICROSOFT WINDOWS operating system file system, gold image 622 may comprise a file system on a C:\ drive, and diff disk may comprise a file such as C:\machine_information.txt.

In the present embodiment, after the diff disk 624 has been created, the VM 610 is shut down, or stopped. Note that, as with other aspects of the present invention discussed herein, the order of operations may not be the same in all embodiments, though those embodiments may all effectuate the present techniques. That is, there may be embodiments where VM 610 is shut down before diff disk 624 has been created. Then VM 610 is created a anew, using the gold image 622 indicated by connection broker 618 and the diff disk 624 created prior to shutting down the VM 610, contains the machine information for the VM 610.

When the VM 610 has been created a new, a process within guest OS 614 of VM 610 may be executed that reads information about the machine that came from diff disk 628 (for instance, using the above example, C:\machine_information.txt) and writes it to locations in a file system of guest OS. Take an example from the MICROSOFT WINDOWS operating system. The process may be a MICROSOFT SYSPREP process that executes upon the recreated guest OS 614 has been started for the first time. The process may read C:\machine_information.txt and write this information to locations in a WINDOWS file system where that machine information is used by the WINDOWS operating system. For instance, a machine name may be read from C:\machine_information.txt by SYSPREP and written to the WINDOWS registry.

Not all information that identifies a VM 610 need be carried over in recreating a VM 610. For instance, it may be that a machine name is generated anew for each recreated VM 610. Connection broker 618 may generate a new machine name for VM 610 when connection broker 618 determines that VM 610 is to be recreated, and sends an indication of this generated machine name to VMHost-M 606-M along with the information 626 that identifies VM 610.

After VM 610 has been recreated and has booted up to the point where it can serve remote presentation session connections, VMHost-M 606-M may send an indication to connection broker 618 that VM 610 is ready to serve remote presentation session connections. Connection broker 618 may then determine that an incoming remote presentation session request from a client computer is to be handled by 618, and broker that session.

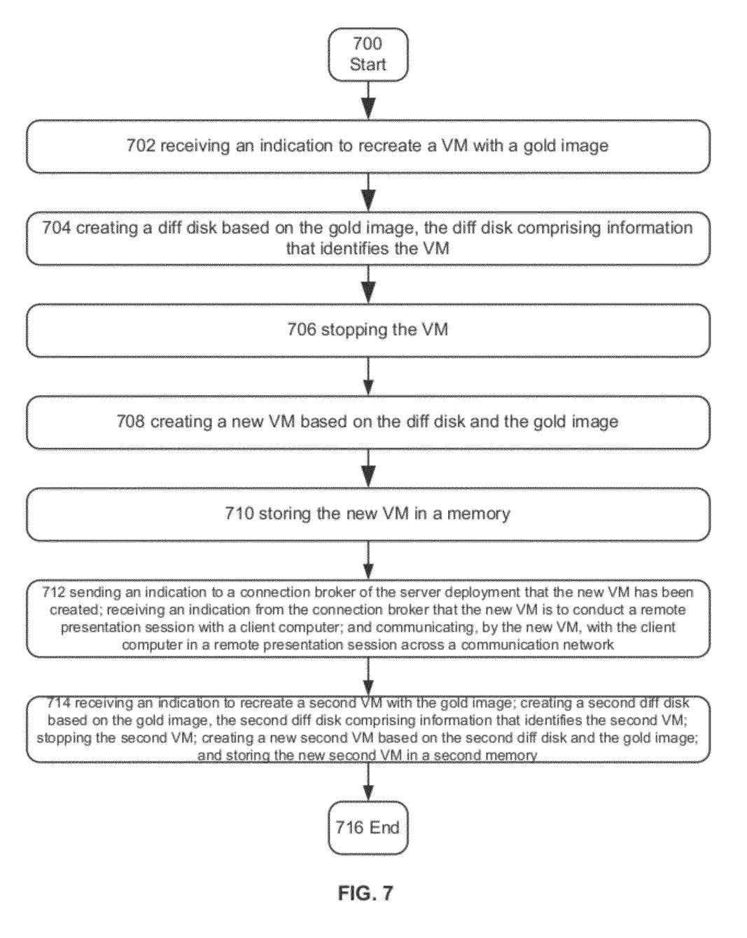

FIG. 7 depicts example operating procedures for preserving user state. The operating procedures of FIG. 7 may be implemented in the server deployment of FIG. 6.

The operating procedures of FIG. 7 begin with operation 700. Operation 700 leads into Operation 702, which depicts receiving an indication to recreate a VM with a gold image. This indication may be initiated by a connection broker of a server deployment and received by a VMHost upon which the VM is hosted. The VM may be recreated periodically, so as to reset the VM to a known state and avoid the VM drifting its state too far from that known state, or to apply a patch, such as an update to a guest OS executing within the VM. The gold image is a base image that is used to image a recreated VM. It does not contain information specific to a VM, but, rather, information and data used by several VMs within the server deployment. For instance, the gold image may comprise a patched OS image without any customization to any one VM. A server deployment may contain multiple gold images—for multiple OS versions (for instance old versions, or test versions that are not yet deployed to production VMs), or multiple types of VMs that are to be deployed. Where a server deployment contains multiple gold images, the gold image to use in the present recreation of the VM may be selected from this plurality of gold images.

Operation 704 depicts creating a diff disk based on the gold image, the diff disk comprising information that identifies the VM. The connection broker may store information specific to a VM, such as a machine identifier or an INTERNET Protocol (IP) address, and when the VM is to be created, use this information specific to the VM and the gold image to create a diff disk (or differencing disk) that is a file (such as an image file) used to recreate the VM. The gold image contains the non-machine specific information and the diff disk contains the machine specific information, so together, they may be used to recreate the VM with its machine state preserved.

Operation 704 may comprise executing a process within the new VM that writes information from a portion of the new VM corresponding to the diff disk to a portion of the new VM corresponding to the gold image. That is, the diff disk may comprise writing a file to a known location in a file system of the guest OS of the new VM. Then, where the guest OS is configured to process this file upon boot up, or a user log in, the file may be processed and that unique machine state may be populated to the guest OS as a whole. For instance, the gold image may comprise a base guest OS image that contains an entry for an IP address for the guest OS. Where this IP address is stored in the diff disk, when the guest OS boots up, it may read the diff disk for the IP address, and copy it to the entry for the IP address in the guest OS or otherwise configure the guest OS to use this IP address.

The gold image itself may also comprise a diff disk—it may be chained. There may be a gold image that is the “parent” image for the present gold image. From this parent image, one or more diff disks may descend in a hierarchy, each diff disk modifying or complementing information in the parent image. In this way, the present gold image may itself comprise the parent gold image plus one or more child diff disks.

Operation 706 depicts stopping the VM. This may include the VMHost sending a machine shut down signal to the VM, and sending an indication to the connection broker of the server deployment that the VM is not available to serve further remote presentation sessions.

Operation 708 depicts creating a new VM based on the diff disk and the gold image. As discussed with respect to operation 704, this may comprise a combination of imaging the VM based on the gold image, and then executing commands within a guest OS of the gold image to process machine-specific information contained within the diff disk, which is embodied as a file stored in a known location of a file system of the guest OS.

Operation 710 depicts storing the new VM in a memory. The new VM may be stored in a memory of the VM host so that it persists, and is available for further processing.

Operation 712 depicts sending an indication to a connection broker of the server deployment that the new VM has been created; receiving an indication from the connection broker that the new VM is to conduct a remote presentation session with a client computer; and communicating, by the new VM, with the client computer in a remote presentation session across a communication network. Once the VM has been recreated (also referred to as the new VM being created), and the VM is available to serve remote presentation sessions, the VMHost of the VM may send an indication to the connection broker that the VM is available to serve remote presentation sessions, and the connection broker will then allocate remote presentation sessions to the recreated VM according to its allocation policy.

Operation 714 depicts receiving an indication to recreate a second VM with the gold image; creating a second diff disk based on the gold image, the second diff disk comprising information that identifies the second VM; stopping the second VM; creating a new second VM based on the second diff disk and the gold image; and storing the new second VM in a second memory. A given gold image may be used to recreate multiple VMs. It is the diff disks that contains machine specific information that preserves machine state. So, a first VM and a second VM may be recreated with the same gold image, and then they are given their unique machine state because the first VM is recreated with the first diff disk and the second VM is recreated with a different diff disk—the second diff disk.

At the conclusion of operation 714, the operation procedures move to operation 712 where the operation procedures of FIG. 7 end.

### CONCLUSION

While the present invention has been described in connection with the preferred aspects, as illustrated in the various figures, it is understood that other similar aspects may be used or modifications and additions may be made to the described aspects for performing the same function of the present invention without deviating there from. Therefore, the present invention should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for preserving state of a user account across a plurality of virtual machines (VMs) of a VM deployment, comprising:
receiving an indication to conduct a remote presentation session with a client computer of the user account and a first VM of the plurality of VMs;
associating a virtual hard drive (VHD) with the first VM;
causing the execution of a process within the first VM, the process mapping a file of a file system of the first VM to the VHD; and
in response to an indication received from the client computer to modify the file, modifying the VHD.

2. The method of claim 1, further comprising:
receiving an indication to conduct a second remote presentation session with the client computer of the user account or a second client computer of the user account and a second VM of the plurality of VMs;
associating the virtual hard drive (VHD) with the second VM;
causing the execution of a process within the second VM, the process mapping a file of a file system of the second VM to the VHD; and
in response to an indication received from the client computer to modify the file of the second VM, modifying the VHD.

3. The method of claim 1, wherein causing the execution of a process within the first VM, the process mapping a file location of a file system of the first VM to the VHD comprises:
sending the process an indication of a roaming policy; and
causing the execution of a process within the first VM, the process mapping the file location of the file system of the first VM to the VHD based on the roaming policy.

4. The method of claim 1, further comprising:
determining that the user account has not logged into the first VM since the first VM was most recently created.

5. The method of claim 1, wherein causing the execution of a process within the first VM, the process mapping a file of a file system of the first VM to the VHD, comprises:
the process creating a mount point, a symbolic link, or a hard link between the file and the VHD.

6. The method of claim 1, wherein causing the execution of a process within the first VM, the process mapping a file of a file system of the first VM to the VHD, comprises:
causing the process to execute within a guest operating system (OS) upon the user account logging into the guest OS.

7. The method of claim 1, wherein associating a virtual hard drive (VHD) with the first VM comprises;
modifying the first VM such that a guest operating system (OS) mounts the VHD upon the user account logging into the guest OS.

8. The method of claim 7, wherein the guest OS mounts a plurality of VHDs upon the user account logging into the guest OS, and wherein causing the execution of a process within the first VM, the process mapping a file of a file system of the first VM to the VHD, comprises:
determining that data stored in the VHD corresponds to the user account.

9. The method of claim 1, wherein associating a VHD with the first VM comprises:
determining that the VHD of a plurality of VHDs that corresponds to the user account based on data stored in the VHD.

10. A system for preserving state of a virtual machine (VM), comprising:
a processor; and
a memory communicatively coupled to the processor, the memory bearing processor-executable instructions that, when executed on the processor, cause the processor to perform operations comprising:
receiving an indication to recreate a VM with a first image file that comprises information about a guest operating system (OS) that is shared among at least two VMs in a server farm in which the VM executes;
creating a second image file based on the first image file, the second image file comprising information that uniquely identifies the VM among a plurality of VMs in the server farm;
stopping the VM;
creating a new VM based on the first image file and the second image file; and
storing the new VM in a memory.

11. The system of claim 10, wherein the memory further bears processor-executable instructions that, when executed on the processor, cause the processor to perform operations comprising:
receiving an indication to recreate the new VM with a third image file that comprises information about a guest operating system (OS) that is shared among at least two VMs the server farm;
creating a fourth image file based on the third image file, the fourth image file comprising information that uniquely identifies the VM among a plurality of VMs in the server farm;
stopping the new VM;
creating a second new VM based on the third image file and the fourth image file; and
storing the second new VM in a memory.

12. The system of claim 10, wherein the new VM is one of a plurality of VMs in a server deployment, and the memory further bears processor-executable instructions that, when executed on the processor, cause the processor to perform operations comprising:
sending an indication to a connection broker of the server deployment that the new VM has been created;
receiving an indication from the connection broker that the new VM is to conduct a remote presentation session with a client computer; and
communicating, by the new VM, with the client computer in a remote presentation session across a communication network.

13. The system of claim 10, wherein the memory further bears processor-executable instructions that, when executed on the processor, cause the processor to perform operations comprising:
receiving an indication to recreate a second VM with the first image file;
creating a third image file based on the first image file, the third image file comprising information that uniquely identifies the second VM among the plurality of VMs in the server farm;
stopping the second VM;
creating a new second VM based on the first image file and the third image file; and
storing the new second VM in a second memory.

14. The system of claim 10, wherein the memory further bears processor-executable instructions that, when executed on the processor, cause the processor to perform operations comprising:
executing a process within the new VM that writes information from a portion of the new VM corresponding to the second image file to a portion of the new VM corresponding to the first image file.

15. The system of claim 10, wherein the second image file corresponds to a file in a guest OS of the new VM that comprises the information that identifies the VM.

16. The system of claim 10, wherein the information that uniquely identifies the VM among the plurality of VMs in the server farm comprises a machine identifier or an INTERNET Protocol (IP) address.

17. The system of claim 10, wherein the first image file comprises a third image file and a fourth image file that comprises in indication of changes to be made to the third image file.

18. The system of claim 10, wherein receiving an indication to recreate a VM with the first image file comprises:
receiving an indication of the first image file drawn from a plurality of image files.

19. A computer-readable storage medium for preserving state on a virtual machine (VM) deployment bearing computer-readable instructions, that when executed on a computer, cause the computer to perform operations comprising:
receiving from a connection broker of the server deployment an indication to recreate a VM, an indication of a first image with which to recreate the VM, the first image file comprising information about a guest operating system (guest OS) that is shared among at least two VMs in a server farm in which the VM executes), and an indication of information that uniquely identifies the VM among a plurality of VMs in the server farm;
creating a second image file based on the first image file, the second image file comprising the information that uniquely identifies the VM;
stopping the VM;
creating a new VM based on the first image file and the second image file;
sending the connection broker an indication that the new VM is ready to conduct a remote presentation session;
receiving an indication from the connection broker for the new VM to conduct a remote presentation session with a client computer of a user account;
determining a virtual hard drive (VHD), the VHD comprising data of the user account;
associating the VHD with the new VM, such that a guest OS of the new VM will mount the VHD in response to being executed;
causing the execution of a process within the new VM, the process mapping a file of a file system of the first VM to the VHD; and
in response to an indication received from the client computer in the remote presentation session to modify the file, modifying the VHD.

20. The computer-readable storage medium of claim 19, further bearing computer-readable instructions, that when executed on the computer, cause the computer to perform operations comprising:
receiving from the connection broker an indication to recreate a second VM, an indication of the first image file, and an indication of information that uniquely identifies the second VM among the plurality of VMs in the server farm;
creating a third image file based on the first image file, the third image file comprising the information that uniquely identifies the second VM among the plurality of VMs in the server farm;
stopping the second VM;
creating a new second VM based on the first image file and the third image file;
sending the connection broker an indication that the new second VM is ready to conduct a remote presentation session;
receiving an indication from the connection broker for the new second VM to conduct a remote presentation session with the client computer of the user account or a second client computer of the user account;
associating the VHD with the new second VM, such that a guest OS of the new second VM will mount the VHD in response to being executed;
causing the execution of a process within the new second VM, the process mapping a file of a file system of the new second VM to the VHD; and
in response to an indication received from the client computer or the second client computer in the remote presentation session to modify the file of the new second VM, modifying the VHD.
